(19) United States
(12) Patent Application Publication
(10) Pub. No.: US 2019/0033190 A1
(43) Pub. Date: Jan. 31, 2019

(54) METHOD FOR DETERMINING THE VISCOSITY OF A CONVEYING FLUID CONVEYED BY MEANS OF A PUMP

(71) Applicant: Sulzer Management AG, Winterthur (CH)

(72) Inventors: Arrigo BERRETTA-MÜLLER, Ehrendingen (CH); Stefan BERTEN, Winterthur (CH); Thomas WATTINGER, Ennetbaden (CH)

(21) Appl. No.: 16/034,439

(22) Filed: Jul. 13, 2018

(30) Foreign Application Priority Data
Jul. 27, 2017 (EP) 17183471.6

(51) Int. Cl. G01N 11/02; F04B 51/00

(52) U.S. Cl. CPC G01N 11/02; F04B 2205/14; F04B 51/00

(57) ABSTRACT

A method for determining the viscosity of a conveying fluid conveyed by a pump, in which an operating value is detected and is fed to an evaluation unit. The method includes providing a reference fluid, recording a reference performance curve resulting from the reference fluid during test operation of the pump at a predetermined operating parameter of the pump, recording an operating performance curve resulting from the conveying fluid during conveying operation of the pump at the predetermined operating parameter of the pump, determining the viscosity of the conveying fluid from a deviation of the operating performance curve from the reference performance curve by a viscosity correction algorithm stored in the evaluation unit.

### CROSS-REFERENCE TO RELATED APPLICATION

This application claims priority to European Application No. 17183471.6, filed Jul. 27, 2017, the contents of which are hereby incorporated herein by reference.

### BACKGROUND

### Field of the Invention

The invention relates to a method for determining the viscosity of a conveying fluid conveyed by a pump. The invention further relates to a pump for performing a method wherein an operating value is detected and is fed to an evaluation unit.

### Background of the Invention

The characteristics of a pump, such as pump head, flow rate, pumping power and efficiency depend crucially on the viscosity of the fluid conveyed by the pump. Knowing the viscosity is therefore important for the optimum adjustment of the pump during operation.

The viscosity is detected in the laboratory (off-line) or during operation of the pump (on-line) via a viscometer or a viscosity sensor. The operating parameters of the pump for optimum operation can then be derived from the determined viscosity. For this purpose, performance curves according to FIG. 2 are used which are defined in relation to a reference fluid. Water is usually used as reference fluid. Using so-called correction factors, which are empirically determined and known from literature, the performance behavior can then be predicted in dependence on the flow rate.

In practice, this method is used to infer from the performance behavior of a pump under laboratory conditions, typically with water as reference fluid, to the performance behavior of the pump under operating conditions with fluids of other, usually higher viscosity. For this purpose, in the course of the acceptance test under laboratory conditions, typically with water as reference fluid, the performance curves of the pump are determined. Provided that the viscosity of the conveying fluid is known, the performance behavior under changed viscosity conditions can then be predicted via the correction factors. This method known from the state of the art enables operating parameters of a pump, such as rotational speed and flow rate, to be adapted to the viscosity of the respective fluid, to achieve a certain pumping power.

### SUMMARY

There are basically two different methods for determining the viscosity: (1) deriving the viscosity from the time required to allow a certain volume of fluid to flow through a capillary. (2) deriving the viscosity from shear forces.

A major disadvantage of off-line methods for the determination of viscosity is that they can only be performed in relatively large time intervals and are therefore unsuitable for fluids, whose viscosity is subject to high fluctuations, which is common in high viscosity fluids. A major disadvantage of on-line methods for the determination of viscosity is that they require a complex measuring arrangement and are therefore prone to failure.

It is therefore an object of the invention to provide a method for determining the viscosity of a conveying fluid, which method can be used cost-effectively on-line during operation of the pump, can detect the change in the viscosity of the conveying fluid in a timely manner and manages with measured variables that are usually detected during operation of the pump.

The objects of the invention meeting this problem are characterized by the features described herein.

Thus, the invention relates to a method for determining the viscosity of a conveying fluid conveyed by a pump, wherein an operating value is detected and is fed to an evaluation unit, and the method comprises:
providing a reference fluid,
recording a reference performance curve resulting from the reference fluid during test operation of the pump at a predetermined operating parameter of the pump,
recording an operating performance curve resulting from the conveying fluid during conveying operation of the pump at the predetermined operating parameter of the pump,
determining the viscosity of the conveying fluid from a deviation of the operating performance curve from the reference performance curve by a viscosity correction algorithm stored in the evaluation unit.

In the method according to the invention for determining the viscosity of a fluid conveyed, the viscosity is determined by a deviation of an operating performance curve resulting during conveying operation of the pump from a reference performance curve resulting with a reference fluid during test operation of the pump by a viscosity correction algorithm stored in the evaluation unit. This algorithm is essentially based on the correction factors known from the state of the art. This means that the method known from the state of the art for predicting the operating performance curve of a pump with known viscosity of the fluid is thus reversed, that the deviation of the operating performance curve from the reference performance curve is used to infer indirectly from this fact to the viscosity of the conveying fluid. For this purpose, the difference between the reference performance curve measured under laboratory conditions and the operating performance curve measured under operating conditions for the conveying fluid to be investigated is used in an algorithm, which derives the viscosity of the conveying fluid in consideration of the correction factors.

Within the framework of this invention, as performance curve can be used, for example the Q-H performance curve in which the conveying head is plotted above the flow rate, the Q-P performance curve in which the power is plotted above the flow rate or the Q-Eta performance curve in which the efficiency is plotted above the flow rate. Of course, other types of performance curves can also be used for the method according to the invention.

Furthermore, the term power is to be understood as the so-called coupling power, i.e. the power, which is actually put into the pump shaft. Therefore, power does not mean the power that the pump motor receives. In addition, it should be mentioned, that the efficiency Eta indicates the quotient of hydraulic power (conveying head times flow rate times density times acceleration of gravity) and the coupling power.

Furthermore, within the framework of the invention, an operating parameter is to be understood as a target parameter that can be adjusted directly at the pump. In contrast, an operating value is an actual value that can be measured or detected by means of a sensor.

An essential advantage of the method according to the invention is the fact, that the viscosity of the fluid conveyed can be determined in relatively short time intervals. In doing so, it is possible to determine the viscosity of highly viscous fluids, whose viscosity is subject to high fluctuations. Another advantage is the fact that no additional measuring devices are required at the pump, but the method manages with measured variables that are available in the operation of the pump anyway. As a result, the process is less prone to failure and cost-effective.

In a preferred embodiment, the reference fluid is water, as the correction factors used in the algorithm can be taken from literature.

Preferably, but not necessarily, the conveying fluid can be a highly viscous fluid, as this usually shows strong viscosity fluctuations during conveying.

In an embodiment that is very important in practice, the operating value is the power of the pump and/or the rotational speed of the pump and/or the pressure of the fluid conveyed and/or the volume flow of the fluid conveyed and/or the density of the fluid conveyed and/or the temperature of the fluid conveyed. The mentioned operating values are usually measured during operation of a pump and are therefore immediately available.

It has proved to be advantageous if the operating value is detected by a sensor, in particular of a speed sensor and/or of a pressure sensor and/or of a volume flow sensor and/or of a density sensor and/or of a temperature sensor. Usually pumps include the sensors.

Preferably, but not necessarily, the operating value can be detected at a frequency of up to 1 minute. As a result, it is possible to react to short-term changes of the operating value, in order to detect viscosity fluctuations in a timely manner.

In a preferred embodiment, the determination of the viscosity of the conveying fluid is carried out periodically, in particular daily, hourly. This allows a continuous monitoring of the viscosity.

Alternatively, it is of course also possible that the determination of the viscosity of the conveying fluid is carried out if required, in particular with short-term change of the operating value. As a result, it is possible to react specifically to changes in the operating value.

It is also advantageous, if the predetermined operating parameter is the power of the pump and/or the rotational speed of the pump and/or the volume flow of the fluid conveyed. Usually these operating parameters can be adjusted directly at the pump. In addition, the correction factors for these operating parameters are known from literature.

It is also advantageous if the evaluation unit is a data processing unit. This makes it easy to program the viscosity correction algorithm.

Finally, it proved to be advantageous, if the data processing unit is integrated into the pump. As a result, the information from operating values and operating parameters can be easily transferred to the data processing unit. Alternatively, it is of course also possible to arrange the data processing unit separately from the pump.

The present invention further relates to a pump for performing the method according to the invention, wherein the pump comprises a sensor for detecting an operating value and an evaluation unit with a viscosity correction algorithm and the detected operating value can be fed to the evaluation unit.

In a preferred embodiment, the evaluation unit is a data processing unit. Hereby, it proved to be advantageous, if the data processing unit is integrated into the pump.

The method according to the invention will be explained in more detail with reference to figures.

### BRIEF DESCRIPTION OF THE DRAWINGS

The invention will be explained in more detail hereinafter with reference to the drawings.

FIG. 1 is a diagram from which the method according to the invention comes out, and

FIG. 2 show pump performance curves of a conveying fluid relative to a reference fluid.

### DETAILED DESCRIPTION OF THE EMBODIMENTS

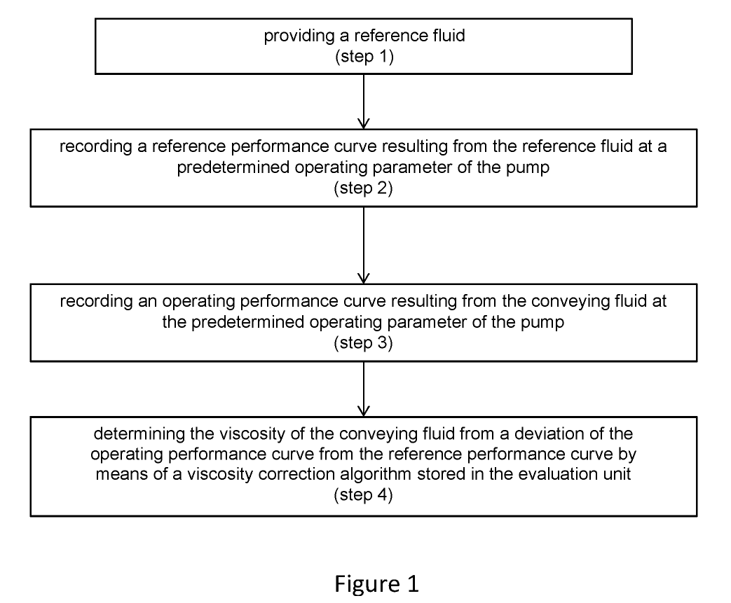

According to FIG. 1, the method according to the invention has the following steps:

providing a reference fluid (step 1)
recording a reference performance curve resulting from the reference fluid at a predetermined operating parameter of the pump (step 2),
recording an operating performance curve resulting from the conveying fluid at the predetermined operating parameter of the pump (step 3),
determining the viscosity of the conveying fluid from a deviation of the operating performance curve from the reference performance curve by a viscosity correction algorithm stored in the evaluation unit (step 4).

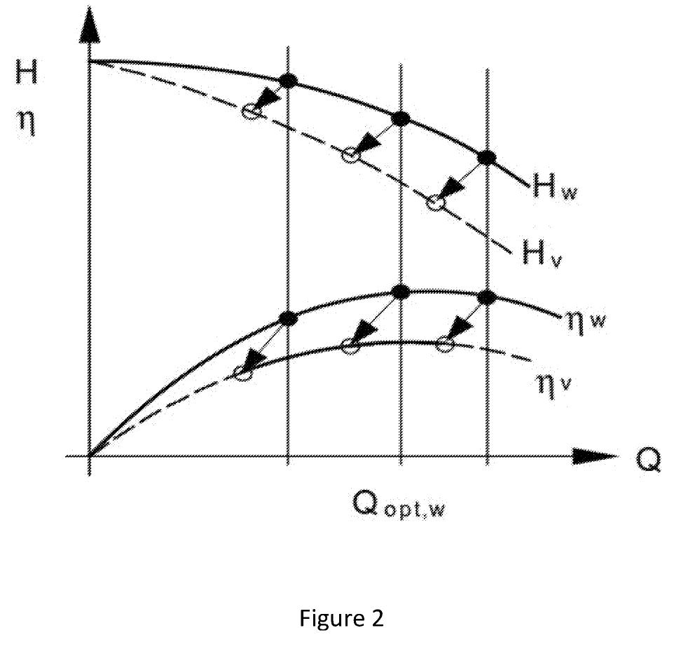

FIG. 2 shows a diagram with reference performance curves (H_{W}, Eta_{W}) and corresponding operating performance curves (H_{V}, Eta_{V}) at a certain rotational speed of the pump. The performance curves are plotted above the flow rate (Q). The curves H_{W} and Eta_{W} result from step 2 according to the invention and the curves H_{V} and Eta_{V} result from step 3 of the method. The viscosity can be inferred by the viscosity correction algorithm from the deviation of curve H_{V} from curve H_{W} or curve Eta_{V} from curve Eta_{W} (step 4).

1. A method for determining the viscosity of a conveying fluid conveyed by a pump, an operating value being detected and fed to an evaluation unit, the method comprising:
providing a reference fluid;
recording a reference performance curve resulting from the reference fluid during test operation of the pump at a predetermined operating parameter of the pump;
recording an operating performance curve resulting from the conveying fluid during conveying operation of the pump at the predetermined operating parameter of the pump; and
determining the viscosity of the conveying fluid from a deviation of the operating performance curve from the reference performance curve by a viscosity correction algorithm stored in the evaluation unit.

2. The method according to claim 1, wherein the reference fluid is water.

3. The method according to claim 1, wherein the conveying fluid is a highly viscous fluid.

4. The method according to claim 1, wherein the operating value is at least one of the power of the pump, a rotational speed of the pump, a pressure of the fluid conveyed, a volume flow of the fluid conveyed, a density of the fluid conveyed, and a temperature of the fluid conveyed.

5. The method according to claim 1, further comprising detecting the operating value with a sensor.

6. The method according to claim 5, wherein the operating value is detected at a frequency of up to 1 minute.

7. The method according to claim 1, wherein the determination of the viscosity of the conveying fluid is carried out periodically, hourly.

8. The method according to claim 1, wherein the determination of the viscosity of the conveying fluid is carried out if required, in particular with short-term change of the operating value.

9. The method according to claim 1, wherein the predetermined operating parameter is at least one of a power of the pump, a rotational speed of the pump, and a volume flow of the fluid conveyed.

10. The method according to claim 1, wherein the evaluation unit is a data processing unit.

11. The method according to claim 10, wherein the data processing unit is integrated into the pump.

12. A pump for performing a method according to claim 1, wherein the pump comprising:
a sensor configured to detect an operating value and an evaluation unit with a viscosity correction algorithm and the detected operating value capable of being fed to the evaluation unit.

13. The pump according to claim 12, wherein the evaluation unit is a data processing unit.

14. The pump according to claim 13, wherein the data processing unit is integrated into the pump.

15. The method according to claim 5, wherein the sensor is at least one of a speed sensor, a pressure sensor, a volume flow sensor, a density sensor and a temperature sensor.

16. The method according to claim 7, wherein the determination of the viscosity of the conveying fluid is carried out daily or hourly.
